(19) United States
(12) Patent Application Publication
(10) Pub. No.: US 2025/0104209 A1
(43) Pub. Date: Mar. 27, 2025

(54) METHOD FOR CHARACTERISING THE BEHAVIOUR OF A ROTATING SHAFT USING EQUIVALENT ELLIPSES

(71) Applicant: SKF Magnetic Mechatronics, Saint-Marcel (FR)

(72) Inventors: Pierre BORNERT, Vernon (FR); Joël MOUTERDE, Blaru (FR); Joaquim DA SILVA, Sennely (FR)

(21) Appl. No.: 18/888,935

(22) Filed: Sep. 18, 2024

(30) Foreign Application Priority Data
Sep. 25, 2023 (FR) 2310162

(51) Int. Cl. G06T 7/00; G06T 11/20

(52) U.S. Cl. CPC G06T 7/0002; G06T 11/203; G06T 11/206; G06T 2207/20084

(57) ABSTRACT

A method for characterising the behaviour of a rotating shaft using equivalent ellipses. The method for characterising the behaviour of a rotating shaft comprises the following steps: acquiring at least two input signals over a predetermined period comprising measurements representing the movement of the rotating shaft (step 10); determining two components of the input signals, the components being orthogonal to each other (step 20); merging the two components into a bivariate signal (step 30); time-frequency decomposing the bivariate signal into spectral elements (step 40); determining an equivalent ellipse for each spectral element (step 50); and extracting at least one characterisation indicator of the rotating shaft based on parameters of the equivalent ellipse (step 80).

### CROSS-REFERENCE TO RELATED APPLICATION

This application claims priority to French Application No. 2310162, filed Sep. 25, 2023, the entirety of which is hereby incorporated by reference.

### FIELD

The present disclosure relates to the characterisation of a shaft rotating about an axis of rotation.

More specifically, the present disclosure relates to the characterisation of the gyroscopic effects and deformations of a rotating shaft in order to facilitate the control, modelling, monitoring, diagnosis and maintenance thereof.

### BACKGROUND

A perfectly balanced rotating system, such as a rotating shaft, rotates about an axis of rotation such that said axis of rotation is immobile relative to its theoretical position, and therefore relative to the environment close to the rotating shaft.

However, faults, deformations, gyroscopic effects or even effects due to the force of gravity can cause the axis of rotation to shift relative to its theoretical position during the rotation of said rotating shaft. This is the case, for example, for deformations of the rotating shaft due to flexible Eigen-modes, with these modes deforming the shaft as a function of the speed of rotation of said shaft.

When such defects are present, the axis of rotation is not immobile and vibrates. It moves away from its theoretical position along a particular trajectory. More specifically, each point on the axis of rotation can move away from its theoretical position, and two points on the axis of rotation at two different ends of the shaft can have a different trajectory.

The properties of a rotating shaft are conventionally understood through a lateral analysis of parameters. The parameters are values of radial quantities such as the position or the radial speed of the shaft, having a non-zero component in a plane orthogonal to the axis of rotation.

The changes in these quantities often need to be characterised depending on whether or not the shaft is rotating. However, many causes can influence the rotational behaviour of a rotating shaft and it is difficult to precisely characterise such behaviour.

### SUMMARY

Therefore, the aim of the present disclosure is to overcome the aforementioned disadvantages.

The aim of the present disclosure is a method for characterising the behaviour of a rotating shaft, the method comprising the following steps:
a) acquiring at least two input signals over a predetermined period, the input signals comprising measurements representing the movement of the rotating shaft, the measurements, associated with a vector quantity, being non-collinear to each other and optionally coplanar with a plane intersecting the axis of rotation of the shaft;
b) determining two components of the input signals, the components being orthogonal to each other and optionally to the axis of rotation;
c) merging the two components into a bivariate signal;
d) time-frequency decomposing the bivariate signal into spectral elements;
e) determining an equivalent ellipse for each spectral element; and
f) extracting at least one characterisation indicator of the rotating shaft based on parameters of the equivalent ellipse.

The gyroscopic effects and the deformations of the rotor, notably the flexible modes, are thus simpler to consider subject to frequency decomposition of the input signals. Indeed, the rotating effects of these deformations are asynchronous, in other words, their frequencies are not directly linked to the rotation frequency of the shaft, and are therefore more easily characterised using a frequency decomposition that can highlight a rotating orbit, also called an equivalent ellipse, for each frequency, with each orbit rotating at a specific speed corresponding to the considered frequency.

The present disclosure therefore enhances the characterisation of a rotating shaft, allowing applications of the control, identification, modelling, monitoring or diagnostic type.

Advantageously, the input signals include measurements of the position, or speed, or acceleration, or force, or magnetic field, or magnetic induction of the rotating shaft.

In various embodiments, the time-frequency decomposition step is carried out using a Fourier, or wavelet, transform, or by filtering, or using a quaternionic Fourier transform.

In a particular embodiment, the step of determining an equivalent ellipse includes computing Euler parameters of said equivalent ellipse.

Advantageously, the method comprises a step of computing the spectral density of the time-frequency decomposition, and a step of computing Stokes parameters based on said spectral density.

In one embodiment, the at least one characterisation indicator includes a polarisation rate, and/or an indicator of circularity and/or amplitude and/or orientation and/or direction of rotation and/or sign and/or synchronisation of an equivalent ellipse.

Advantageously, the method comprises a step of introducing the at least one characterisation indicator into a neural network in order to classify said indicator as a function of the rotation of the shaft and to link it to a previously listed anomaly.

In a particular embodiment, the method comprises a step of displaying the at least one extracted characterisation indicator so that it can be read by an operator.

Advantageously, the method comprises a step of generating a representation of the at least one indicator in the form of images, then a step of creating a collection of images based on the images generated in the generation step, a step of providing a classification tool with said collection of images, and a step of classifying, using the classification tool, the images as a function of the rotation of the rotating shaft and/or of the anomalies present in the collection of images.

Advantageously, the classification tool is a neural network, preferably a convolutional neural network, even more preferably a convolutional neural network with dimensions that are greater than or equal to the dimensions of the images of the collection of images.

Advantageously, the method comprises a step of displaying an image of at least one equivalent ellipse.

In one embodiment, steps a) to f) are carried out at least a second time for an additional plane intersecting the axis of rotation of the shaft and distinct from said plane, the method further comprising a step of comparing the characterisation indicators of the planes and/or creating new characterisation indicators common to the two planes.

A further aim of the present disclosure is a computer-implemented method comprising the steps of the method as defined above. The method can be implemented on a real-time target, notably in a magnetic bearing control cabinet.

### BRIEF DESCRIPTION OF THE DRAWINGS

FIG. 1 is a schematic representation of the various steps of the method according to the present disclosure; and

FIG. 2 is a representation of an example of an equivalent ellipse and its Euler parameters as determined in the method according to the present disclosure.

### DETAILED DESCRIPTION

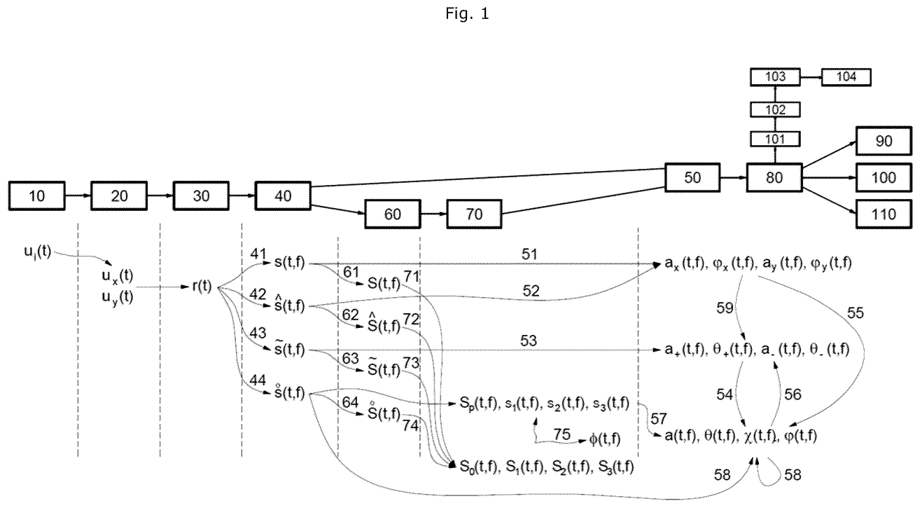

FIG. 1 schematically shows the various steps of the method according to the present disclosure.

The method according to the present disclosure is used to characterise the behaviour of a rotating shaft. A rotating shaft is understood to be a shaft that is free to rotate about an axis of rotation. The rotating shaft is a shaft of a rotating machine, for example.

In order to implement the method, a step 10 of acquiring input signals is initially carried out.

At least two input signals are acquired over a predetermined period. The predetermined period is several seconds, for example.

The input signals include measurements representing the movement of the rotating shaft. For example, the input signals include measurements of the position, or speed, or acceleration, or force, or magnetic field, or even of the magnetic induction of the rotating shaft. The input signals are acquired, for example, using sensors configured to measure these quantities.

In general, a vector quantity is measured in terms of several spatially distributed components sensitive to the rotation of the shaft. The spatial distribution of these components is used to evaluate the movement of the rotor.

A particular case is that of measurements that are non-collinear to each other and are coplanar with a plane intersecting the axis of rotation of the shaft. Two non-collinear measurements can be used to characterise the behaviour of the rotating shaft in a plane intersecting the axis of rotation of the shaft. Additional measurements allow greater precision for said characterisation.

Measurements that are not coplanar with a plane intersecting the axis of rotation of the shaft nevertheless can be returned by projecting into a reference plane intersecting the axis of rotation of the shaft.

For M measurements with M≥2, M input signals u₁(t) to u_{M}(t) are obtained, with t denoting the time covering the acquisition of the measurements, the set of values of which is denoted by T, in other words dates, which t can assume.

An intersecting plane is understood to be a plane in which the measurements are taken that intersect the axis of rotation of the rotating shaft. The intersecting plane is, for example, orthogonal to the axis of rotation or is not orthogonal to the axis of rotation.

If the intersecting plane is not orthogonal to the axis of rotation, a step 20 is carried out of determining two components of the input signals, with the components being orthogonal to each other and to the axis of rotation. In other words, this step 20 is a change of basis facilitating the subsequent computations.

In the event that the intersecting plane is orthogonal to the axis of rotation, the previous step is intrinsically carried out.

In the event that the axis of rotation is not strictly and precisely defined, with the shaft not always being perfectly cylindrical and/or balanced, and/or non-deformable and/or known, said orthogonal intersecting plane is treated as a study plane that is assumed to be orthogonal to the axis of rotation, or at least sensitive to the rotational movement of the shaft.

In practice, the step 20 of determining the two orthogonal components uₓ(t) and u_{y}(t) is carried out by averaging the projections of the input signals u₁(t) to u_{M}(t) over two orthogonal axes x and y, with these two axes ideally being orthogonal to the axis of rotation. Thus,

$$∀ t ∈ T , \begin{matrix}{u}_{x} ( t ) = {moy}_{i = [ 1 , M ]} ( {Proj}_{x} ( {u}_{i} ( t ) ) ) \\ {u}_{y} ( t ) = {moy}_{i = [ 1 , M ]} ( {Proj}_{y} ( {u}_{i} ( t ) ) )\end{matrix}$$

the components uₓ(t) and u_{y}(t) are now in the study plane, ideally orthogonal to the axis of rotation.

A step 30 is then carried out of merging the two orthogonal components uₓ(t) and u_{y}(t) into a bivariate signal r(t) in order to combine these two components in an equivalent manner in the form of a complex signal, such that:

$$∀ t ∈ T ,$$

$$r ( t ) = {u}_{x} ( t ) + 1 i \cdot {u}_{y} ( t )$$

It also can be expressed as follows:

$$r ( t ) = \{ {u}_{x} ( t ) , {u}_{y} ( t ) \}$$

Or even in vector form:

$$r ( t ) = [ \begin{matrix}{u}_{x} ( t ) \\ {u}_{y} ( t )\end{matrix} ]$$

A step 40 is then carried out of frequency decomposing the bivariate signal r(t) into spectral elements characterised by their time-frequency pair (t, f), also called time-frequency cells, with this step being carried out periodically in order to obtain both a temporal and a frequency decomposition, called time-frequency decomposition s(t, f), such that:

$$s ( t , f ) = {spectre}_{t , f} ( r ( τ ) )$$

This time-frequency decomposition step 40 can be carried out in various ways. These various embodiments are described hereafter, with time-frequency decompositions s, or ŝ, or \tilde{s}, or s̊ being provided in continuous form, in other words in analogue and not discrete form. A computer-implemented digital implementation then includes a time and frequency sampling step.

In a first embodiment, denoted 41 in FIG. 1, the time-frequency decomposition step 40 is carried out with a filter bank around each frequency f.

Thus, the time-frequency decomposition s(t, f) is expressed as follows:

$$∀ f ∈ {F}_{+} ,$$

$$∀ t ∈ T ,$$

$$s ( t , f ) = r ( t ) * {h}_{f} ( t )$$

with h_{f} being the impulse response of a bandpass filter centred around the frequency f, with F₊ being all the frequencies that are greater than or equal to 0.

In a second embodiment 42, the time-frequency decomposition step 40 is carried out using a Fourier transform, in particular a short-term single-sided Fourier transform.

As standard, the time-frequency decomposition is expressed as:

$$∀ f \geq 0 , \begin{matrix}{\hat{s}}_{x} ( t , f ) = \frac{1}{dt} \cdot {\int }_{t - dt}^{t} {u}_{x} ( τ ) \cdot {e}^{- 1 i \cdot 2 π \cdot f \cdot τ} \cdot d τ \\ {\hat{s}}_{y} ( t , f ) = \frac{1}{dt} \cdot {\int }_{t - dt}^{t} {u}_{y} ( τ ) \cdot {e}^{- 1 i \cdot 2 π \cdot f \cdot τ} \cdot d τ\end{matrix}$$

In practice, more efficient estimators are preferably used, based on a division into temporal intervals, with time weighting, averaging over several temporal intervals, and overlaps between successive intervals. The formulation is then:

$$∀ t ∈ {T}_{↓} , ∀ f ∈ {F}_{+} , \begin{matrix}{\hat{s}}_{{x}_{k}} ( t , f ) = {\int }_{t - {dt}_{k}^{-}}^{t + {dt}_{k}^{+}} {u}_{x} ( τ ) \cdot {w}_{k} ( τ - t ) \cdot {e}^{- 1 i \cdot 2 π \cdot f \cdot τ} \cdot d τ \\ {\hat{s}}_{{y}_{k}} ( t , f ) = {\int }_{t - {dt}_{k}^{-}}^{t + {dt}_{k}^{+}} {u}_{y} ( τ ) \cdot {w}_{k} ( τ - t ) \cdot {e}^{- 1 i \cdot 2 π \cdot f \cdot τ} \cdot d τ\end{matrix}$$

$$∀ t ∈ {T}_{↓} , ∀ f ∈ {F}_{+} , \begin{matrix}{\hat{s}}_{x} ( t , f ) = {moy}_{k = [ 1 , p ]} ( \frac{{\hat{s}}_{{x}_{k}} ( t , f )}{{w}_{k}^{( 1 )}} ) \\ {\hat{s}}_{y} ( t , f ) = {moy}_{k = [ 1 , p ]} ( \frac{{\hat{s}}_{{y}_{k}} ( t , f )}{{w}_{k}^{( 1 )}} )\end{matrix}$$

With dtₖ⁻ and dtₖ⁺ for k=[1, p] defining a division into p intervals, with possible overlap, around a given date t. Conventionally, this division does not depend on t, and is identical for each cell. The temporal extent of interval k is dtₖ=dtₖ⁻+dtₖ⁺.

The overall temporal extent of the corresponding cell (t,f) is:

$${dt}^{+} = {max}_{k = [ 1 , p ]} ( {dt}_{k}^{+} )$$

$${dt}^{-} = {max}_{k = [ 1 , p ]} ( {dt}_{k}^{-} )$$

$$dt = {dt}^{-} + {dt}^{+}$$

With Et wₖ(t) for τ∈[−dtₖ⁻, dtₖ⁺] for k=[1, p] defining a temporal weighting window for each of these intervals, for example, of the Hanning type. Conventionally, wₖ does not depend on k, which is identical for each interval.

Depending on the estimated spectral quantity, the following compensations need to be introduced:

$$∀ k ∈ [ 1 , p ] , \begin{matrix}{w}_{k}^{( 1 )} = {\int }_{t - {dt}_{k}^{-}}^{t + {dt}_{k}^{+}} {w}_{k} ( τ ) \cdot d τ \\ {w}_{k}^{( 2 )} = {\int }_{t - {dt}_{k}^{-}}^{t + {dt}_{k}^{+}} {w}_{k}^{2} ( τ ) \cdot d τ\end{matrix} ∀ k ∈ [ 1 , p ] , \begin{matrix}{w}_{k}^{( 1 )} = {\int }_{- {dt}_{k}^{-}}^{{dt}_{k}^{+}} {w}_{k} ( τ ) \cdot d τ \\ {w}_{k}^{( 2 )} = {\int }_{- {dt}_{k}^{-}}^{{dt}_{k}^{+}} {w}_{k}^{2} ( τ ) \cdot d τ\end{matrix}$$

In a particular case, the absence of weighting corresponds to wₖ=1, in which case wₖ⁽¹⁾=wₖ⁽²⁾=dtₖ.

In addition, a sub-set of dates is introduced: T_{∇}={tᵢ′, i=[1, m′]}

In a third embodiment 43, the time-frequency decomposition step 40 is carried out using a Fourier transform, in particular a short-term two-sided Fourier transform, also called “Full spectrum” transform, in other words, for a set F of frequencies taking values from the set of real numbers.

Thus, as standard the time-frequency decomposition š (t, f) is expressed as:

$$∀ f ∈ R , \tilde{s} ( t , f ) = \frac{1}{dt} \cdot {\int }_{t - dt}^{t} r ( τ ) \cdot {e}^{- 1 i \cdot 2 π \cdot f \cdot τ} \cdot d τ$$

Or with a division into temporal blocks:

$$∀ t ∈ {T}_{↓} , ∀ f ∈ F , \hat{s} ( t , f ) = {\int }_{t - {dt}_{k}^{-}}^{t + {dt}_{k}^{+}} r ( τ ) \cdot {w}_{k} ( τ - t ) \cdot {e}^{- 1 i \cdot 2 π \cdot f \cdot τ} \cdot d τ$$

$$∀ t ∈ {T}_{↓} , ∀ f ∈ F , \hat{s} ( t , f ) = {moy}_{k = [ 1 , p ]} ( \frac{{\tilde{s}}_{k} ( t , f )}{{w}_{k}^{( 1 )}} )$$

In a fourth embodiment 44, the time-frequency decomposition step 40 is carried out using a Fourier transform, in particular a short-term quaternionic Fourier transform, using the unitary imaginary numbers verifying 1i²=1j²=1k²=1i.1j.1k=−1.

Thus, as standard the time-frequency decomposition s(t, f) is expressed as:

$$∀ f \geq 0 , {s}^{o} ( t , f ) = \frac{1}{dt} \cdot {\int }_{t - dt}^{t} r ( τ ) \cdot {e}^{- 1 j \cdot 2 π \cdot f \cdot τ} \cdot d τ$$

Or with a division into temporal blocks:

$$∀ t ∈ {T}_{↓} , ∀ f ∈ {F}_{+} , {{s}^{o}}_{k} ( t , f ) = {\int }_{t - {dt}_{k}^{-}}^{t + {dt}_{k}^{+}} r ( τ ) \cdot {w}_{k} ( τ - t ) \cdot {e}^{- 1 j \cdot 2 π \cdot f \cdot τ} \cdot d τ$$

$$∀ t ∈ {T}_{↓} , ∀ f ∈ {F}_{+} , {s}^{o} ( t , f ) = {moy}_{k = [ 1 , p ]} ( \frac{{{s}^{o}}_{k} ( t , f )}{{w}_{k}^{( 1 )}} )$$

The expressions of the Fourier transforms provided in embodiments 41 to 44 above form applicable formulae, producing efficient estimators, notably in terms of their formulation with temporal weighting, averaging over several temporal intervals, overlaps between successive intervals, a more general expression of which can be provided with:

$$\overbrace{{s}_{k}} ( t , f ) = \frac{1}{{dt}_{k}} \cdot {\int }_{t - {dt}_{k}^{-}}^{t + {dt}_{k}^{+}} r ( τ ) \cdot {w}_{k} ( τ ) \cdot {e}^{- 1 μ \cdot 2 π \cdot f \cdot τ} \cdot d τ$$

with wₖ being the temporal weighting, and u being defined such that 1μ²=−1. Finally,

$$\overbrace{s} ( t , f ) = {moy}_{k} ( \overbrace{{s}_{k}} ( t , f ) )$$

The index k applied to wₖ(above) or pₖ(below) means that the weighting can differ from one interval to another.

In addition, other frequency transforms can be used, such as wavelet decompositions.

A more general expression is:

$$\overbrace{{s}_{k}} ( t , f ) = {\int }_{t - {dt}_{k}^{-}}^{t + {dt}_{k}^{+}} r ( τ ) \cdot {p}_{k} ( τ , f ) \cdot d τ$$

Even more generally, the time division and the weighting can be varied as a function of the time-frequency cell (t, f):

$$( t , f ) = {\int }_{t - {dt}_{k}^{-} ( t , f )}^{t + {dt}_{k}^{+} ( t , f )} r ( τ ) \cdot {p}_{k} ( t , f ) ( τ ) \cdot d τ$$

The trajectory (orbit) is obtained by inverse transformation, of the following type:

$$s ( t , f ) ( τ ) = {\int }_{f - {df}^{-} ( t , f )}^{f + {df}^{+} ( t , f )} ( \overbrace{s} ( t , v ) \cdot q ( t , f ) ( τ , v ) + \overbrace{s} ( t , - v ) \cdot q ( t , f ) ( τ , - v ) ) \cdot dv$$

With the frequency extent of the cell (t, f) then being df=df⁺+df⁻, the temporal extent of the cell (t, f) being dt=dt⁺+dt⁻.

From each spectral element s(t, f), at a fixed date t and frequency f, it is possible to deduce an equivalent ellipse from the instantaneous orbit. This can be referred to as local in the temporal and frequency sense, in other words, at the date t and frequency f.

Therefore, a step 50 is carried out of determining the equivalent ellipse for each spectral element. Irrespective of the time-frequency decomposition method, the instantaneous orbit can be expressed in the form of a parametric equation such that, for each component x and y, and with sₓ_{ₒ}, s_{y}_{ₒ}, and Øₓ, Ø_{y} being the instantaneous amplitudes and phases:

$${s}_{x} ( t , f ) = {s}_{{x}_{o}} ( t , f ) \cdot cos ( {∅}_{x} ( t , f ) )$$

$${s}_{y} ( t , f ) = {s}_{{y}_{o}} ( t , f ) \cdot cos ( {∅}_{y} ( t , f ) )$$

For a fixed frequency f, covering the time t allows the trajectory to be obtained at this frequency.

This instantaneous orbit assumes the form of an equivalent ellipse, provided that sₓ(t, f), s_{y}(t, f)), \dot{Ø}ₓ (t, f), \dot{Ø}_{y}(t, f) vary slowly as a function of time, for example, during a complete revolution at the frequency f, and in any case for the duration dt of the temporal interval defining the spectral element.

In this case, the date t of the considered spectral element can be distinguished from the time t that evolves in this spectral element and, by introducing the frequency f into the expression of the phases that are assumed to be quasi-linear, the equivalent ellipse is obtained in the form of a temporal parametric equation for each component x and y:

$${{s}^{′}}_{x} ( t , f ) ( τ ) = {a}_{x} ( t , f ) \cdot cos ( 2 \cdot π \cdot f \cdot τ + {φ}_{x} ( t , f ) )$$

$${{s}^{′}}_{y} ( t , f ) ( τ ) = {a}_{y} ( t , f ) \cdot cos ( 2 \cdot π \cdot f \cdot τ + {φ}_{y} ( t , f ) )$$

These parametric equations also can be written as follows, for example:

$${{s}^{′}}_{x} ( t , f ) ( τ ) = {a}_{x} ( t , f ) \cdot ( cos ( 2 \cdot π \cdot f \cdot τ ) \cdot cos ( {φ}_{x} ( t , f ) ) - sin ( 2 \cdot π \cdot f \cdot τ ) \cdot sin ( {φ}_{x} ( t , f ) ) )$$

$${{s}^{′}}_{y} ( t , f ) ( τ ) = {a}_{y} ( t , f ) \cdot ( cos ( 2 \cdot π \cdot f \cdot τ ) \cdot cos ( {φ}_{y} ( t , f ) ) - sin ( 2 \cdot π \cdot f \cdot τ ) \cdot sin ( {φ}_{y} ( t , f ) ) )$$

In order to obtain these parametric equations, notably in the case of a frequency decomposition using a filter bank, the parameters aₓ(t, f), φₓ(t, f), a_{y}(t, f), φ_{y}(t, f) of the equivalent ellipse can be obtained by estimates, such as direct or quadratic averaging or by RMS value, from the instantaneous quantities (τ, f) pour τ∈[t−dt⁻, t+dt⁺].

In the case of a frequency decomposition using a Fourier transform, the parametric equation of the equivalent ellipse is obtained using an inverse Fourier transform of the frequency element:

$${{s}^{′}}_{x} ( t , f ) ( τ ) = 2 \cdot Re ( {\hat{s}}_{x} ( t , f ) \cdot {e}^{1 i \text{.2} π . f . τ} )$$

$${{s}^{′}}_{y} ( t , f ) ( τ ) = 2 \cdot Re ( {\hat{s}}_{y} ( t , f ) \cdot {e}^{1 i \text{.2} π . f . τ} )$$

By forming the associated complex quantity ś(t, f)=\acute{x}ₓ(t, f)+1i. ś_{y}(t, f), in other words, the bivariate representation, it is possible to highlight the decomposition of a parametric equation of the equivalent ellipse in two circles in opposite directions:

$${s}^{′} ( t , f ) ( τ ) = {a}_{-} ( t , f ) \cdot {e}^{1 i . {θ}_{+} ( t , f )} \cdot {e}^{1 i \text{.2} . π , f . τ} + {a}_{+} ( t , f ) \cdot {e}^{1 i . {θ}_{+} ( t , f )} \cdot {e}^{1 i \text{.2} . π , f . τ}$$

With the following parameters obtained following a computation step 59:

$${a}_{+} = \frac{a}{2} \cdot \sqrt{{a}_{x}^{2} + {a}_{y}^{2} + 2 \cdot {a}_{x} \cdot {a}_{y} \cdot sin ( {φ}_{x} - {φ}_{y} )}$$

$${a}_{-} = \frac{a}{2} \cdot \sqrt{{a}_{x}^{2} + {a}_{y}^{2} + 2 \cdot {a}_{x} \cdot {a}_{y} \cdot sin ( {φ}_{y} - {φ}_{x} )}$$

$${θ}_{+} = arctan 2 ( {a}_{x} \cdot sin ( {φ}_{x} ) + {a}_{y} \cdot cos ( {φ}_{y} ) , {a}_{x} \cdot cos ( {φ}_{x} ) - {a}_{y} \cdot sin ( {φ}_{y} ) )$$

$${θ}_{-} = arctan 2 ( {a}_{x} \cdot sin ( {φ}_{x} ) - {a}_{y} \cdot cos ( {φ}_{y} ) , {a}_{x} \cdot cos ( {φ}_{x} ) + {a}_{y} \cdot sin ( {φ}_{y} ) )$$

The characterisation of the equivalent ellipse is straightforward using the two-sided (“full spectrum”) Fourier transform, which can be directly written in polar form:

$$∀ f > 0 , \text{} \begin{matrix}\tilde{s} ( t , f ) & = {a}_{+} ( t , f ) \cdot {e}^{1 i . {θ}_{+} ( t , f )} \\ \tilde{s} ( t , - f ) & = {a}_{-} ( t , f ) \cdot {e}^{− 1 i . {θ}_{-} ( t , f )}\end{matrix}$$

In general, an equivalent ellipse can be determined and plotted by obtaining its Euler parameters.

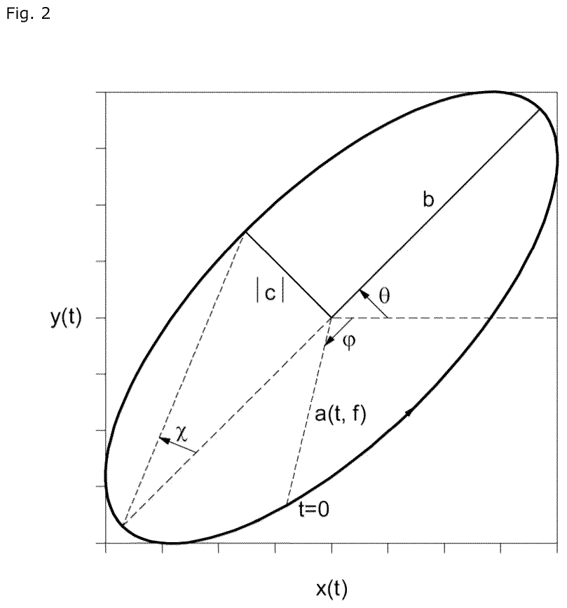

FIG. 2 shows an example of an ellipse and its Euler parameters a(t, f), θ(t, f), χ(t, f), φ(t, f), which fully define an equivalent ellipse, with:

$$a \geq 0$$

$$θ ∈ [ - π / 2 , π / 2 ]$$

$$χ ∈ [ - π / 4 , π / 4 ]$$

$$φ ∈ [ - π , π ]$$

Furthermore, b is the semi-major axis, in other words, the major radius, and c is the semi-minor axis, in other words, the minor radius, the sign of which provides the direction of rotation of the equivalent ellipse.

The parametric equation of the trajectory of the equivalent ellipse is more practical in complex form, since:
an equation of a circle is notably expressed as cos and sin of the same phase;
the axes are dilated in order to obtain an ellipse;
a rotation is applied thereto in order to obtain the desired direction, thus:

$$\begin{matrix}{s}^{′} ( t , f ) ( τ ) = & a ( t , f \cdot {e}^{1 i . θ ( t , f )} \cdot ( cos ( χ ( t , f ) ) \cdot cos ( 2 \cdot π \cdot f \cdot τ + φ ( t , f ) )\end{matrix} + 1 i \cdot sin ( χ ( t , f ) ) \cdot sin ( 2 \cdot π \cdot f \cdot τ + φ ( t , f ) ) )$$

Direction is understood to mean the angle θ of the equivalent ellipse between the major axis and the x-axis. Orientation is understood to mean the direction of rotation describing the trajectory of said ellipse.

This characterisation of the equivalent ellipse is natural with the time-frequency decomposition using a quaternionic Fourier transform, which can be directly placed into Euler form:

$${s}^{o} ( t , f ) = \vert {s}^{o} ( t , f ) \vert \cdot {e}^{1 i . θ ( t , f )} \cdot {e}^{− 1 k . χ ( t , f )} \cdot {e}^{1 j . φ ( t , f )}$$

This parametric equation has the particular advantage of rejecting the temporal parametrisation towards a single exponential term e^{1j.2.π.f.τ} when the inverse Fourier transform is applied to the frequency element in order to obtain the temporal parametric equation of the trajectory of the equivalent ellipse:

$${s}^{′} ( t , f ) ( τ ) \approx \vert {s}^{o} ( t , f ) \vert = {Proj}_{{⊂}_{1 i}} ( {e}^{1 i . θ ( t , f )} \cdot {e}^{− 1 k . χ ( t , f )} \cdot {e}^{1 j . φ ( t , f )} \cdot {e}^{1 j \text{.2} . π . f . τ} )$$

with Proj_{C}_{₁ᵢ} being a projection into the set of complex numbers C₁ᵢ.

More specifically, the step 50 of determining the equivalent ellipse includes a step of computing the Euler parameters of said equivalent ellipse.

Starting from the time-frequency decomposition using a filter bank, a step 51 of computing aₓ and a_{y} is obtained such that:

$$\begin{matrix}∀ t ∈ {T}_{↓} , ∀ f ∈ {F}_{+}^{*} , & \begin{matrix}{a}_{x} ( t , f ) & = \sqrt{\frac{2}{dt} \cdot {\int }_{t − {dt}^{−}}^{t + {dt}^{+}} {s}_{x}^{2} ( τ , f ) \cdot d τ} \\ {a}_{y} ( t , f ) & = \sqrt{\frac{2}{dt} \cdot {\int }_{t − {dt}^{−}}^{t + {dt}^{+}} {s}_{y}^{2} ( τ , f ) \cdot d τ}\end{matrix}\end{matrix}$$

with T_{∇} being a sub-set of T.

Starting from the time-frequency decomposition using a short-term single-sided Fourier transform, a step 52 of computing aₓ, a_{y}, φₓ and φ_{y} is obtained such that:

$$\begin{matrix}∀ t ∈ {T}_{↓} , ∀ f ∈ {F}_{+}^{*} , & \end{matrix} \begin{matrix}\begin{matrix}{a}_{x} ( t , f ) = 2 \cdot \vert {\tilde{s}}_{x} ( t , f ) \vert & {φ}_{x} ( t , f ) = Arg ( {\tilde{s}}_{x} ( t , f ) )\end{matrix} \\ \begin{matrix}{a}_{y} ( t , f ) = 2 \cdot \vert {\tilde{s}}_{y} ( t , f ) \vert & {φ}_{y} ( t , f ) = Arg ( {\tilde{s}}_{y} ( t , f ) )\end{matrix}\end{matrix}$$

Starting from the time-frequency decomposition using a short-term two-sided Fourier transform, a step 53 of computing a₊, a₋, θ₊ and θ₋ is obtained such that:

$$∀ t ∈ {T}_{↓} , ∀ f ∈ {F}_{+}^{*} , \begin{matrix}{a}_{+} ( t , f ) = \vert \tilde{s} ( t , f ) \vert {θ}_{+} ( t , f ) = Arg ( \tilde{s} ( t , f ) ) \\ {a}_{-} ( t , f ) = \vert \tilde{s} ( t , f ) \vert {θ}_{-} ( t , f ) = - Arg ( \tilde{s} ( t , - f ) )\end{matrix}$$

An additional computation step 54 or 55 yields the following Euler parameters:

$$a = \sqrt{2} \cdot \sqrt{{a}_{+}^{2} + {a}_{-}^{2}} a = \sqrt{{a}_{x}^{2} + {a}_{y}^{2}}$$

$$φ = \frac{{θ}_{+} + {θ}_{-}}{2} ou φ = \frac{{φ}_{x} + {φ}_{y}}{2}$$

$$θ = \frac{{θ}_{+} + {θ}_{-}}{2} θ = \frac{1}{2} \cdot arc tan 2 ( 2 \cdot {a}_{x} \cdot {a}_{y} \cdot cos ( {φ}_{x} - {φ}_{y} ) , {a}_{x}^{2} - {a}_{y}^{2} )$$

$$χ = arctan 2 ( {a}_{+} - {a}_{-} , {a}_{+} + {a}_{-} ) χ = \frac{1}{2} \cdot arc sin ( ratio * ( 2 \cdot {a}_{x} \cdot {a}_{y} , {a}_{x}^{2} + {a}_{y}^{2} ) \cdot sin ( {φ}_{x} - {φ}_{y} ) )$$

An inverse computation step 56 is also possible, such that:

$${a}_{+} = \frac{a}{2} \cdot ( cos ( χ ) + sin ( χ ) )$$

$${a}_{-} = \frac{a}{2} \cdot ( cos ( χ ) - sin ( χ ) )$$

$${θ}_{+} = φ + θ$$

$${θ}_{-} = φ - θ$$

The method according to the present disclosure optionally comprises a step 60 of computing the spectral density of the time-frequency decomposition. The spectral densities of each component and the cross-spectral densities between components are used to estimate the energy distribution between the x and y components.

Starting from the time-frequency decomposition using a filter bank, a step 61 of computing the spectral density S is obtained such that:

$$∀ t ∈ {T}_{↓} , ∀ f ∈ {F}_{+} , \begin{matrix}{S}_{x} ( t , f ) = \frac{1}{dt} \cdot {\int }_{t - {dt}^{-}}^{t + {dt}^{+}} {s}_{x}^{2} ( τ , f ) \cdot d τ \\ {S}_{y} ( t , f ) = \frac{1}{dt} \cdot {\int }_{t - {dt}^{-}}^{t + {dt}^{+}} {s}_{y}^{2} ( τ , f ) \cdot d τ \\ {S}_{xy} ( t , f ) = \frac{1}{dt} \cdot {\int }_{t - {dt}^{-}}^{t + {dt}^{+}} {s}_{x} ( τ , f ) \cdot {s}_{y} ( τ , f ) \cdot d τ\end{matrix}$$

Starting from the time-frequency decomposition using a short-term single-sided Fourier transform, a step 62 of computing the spectral density Ŝ is obtained such that:

$$∀ t ∈ {T}_{↓} , ∀ f ∈ {F}_{+}^{*} , \begin{matrix}{\hat{S}}_{x} ( t , f ) = 2 \cdot df \cdot {moy}_{k = [ 1 , p ]} ( \frac{{\vert {\hat{s}}_{{x}_{k}} ( t , f ) \vert}^{2}}{{w}_{k}^{( 2 )}} ) \\ {\hat{S}}_{y} ( t , f ) = 2 \cdot df \cdot {moy}_{k = [ 1 , p ]} ( \frac{{\vert {\hat{s}}_{{y}_{k}} ( t , f ) \vert}^{2}}{{w}_{k}^{( 2 )}} ) \\ {\hat{S}}_{xy} ( t , f ) = 2 \cdot df \cdot {moy}_{k = [ 1 , p ]} ( \frac{{\hat{s}}_{{x}_{k}} ( t , f ) \cdot \overline{{\hat{s}}_{{y}_{k}} ( t , f )}}{{w}_{k}^{( 2 )}} )\end{matrix}$$

Starting from the time-frequency decomposition using a short-term two-sided Fourier transform, a step 63 of computing the spectral density S is obtained such that:

$$∀ t ∈ {T}_{↓} , ∀ f ∈ {F}^{*} , \tilde{S} ( t , f ) = df \cdot {moy}_{k = [ 1 , p ]} ( \frac{{\vert {\hat{s}}_{k} ( t , f ) \vert}^{2}}{{w}_{k}^{( 2 )}} )$$

The following also will be used:

$$∀ t ∈ {T}_{↓} , ∀ f ∈ {F}_{+}^{*} , ( t , f ) = df \cdot {moy}_{k = [ 1 , p ]} ( \frac{{\tilde{s}}_{k} ( t , f ) \cdot {\tilde{s}}_{k} ( t , - f )}{{w}_{k}^{( 2 )}} )$$

Starting from the time-frequency decomposition using a short-term quaternionic Fourier transform, a step 64 of computing the spectral density S̊ is obtained such that: ∀t∈T_{∇}, ∀f∈F₊,

$${S}^{o} ( t , f ) = df \cdot {moy}_{k = [ 1 , p ]} ( \frac{{\vert {{s}_{k}}^{o} ( t , f ) \vert}^{2}}{{w}_{k}^{( 2 )}} ) + df \cdot {moy}_{k = [ 1 , p ]} ( \frac{{{s}_{k}}^{o} ( t , f ) \cdot 1 j \cdot \overline{{{s}_{k}}^{o} ( t , f )}}{{w}_{k}^{( 2 )}} )$$

Based on these spectral densities S, Ŝ, Ś, and S̊, a step 70 is carried out of computing the Stokes parameters S₀, S₁, S₂, and S₃ of at least one equivalent ellipse.

The Stokes parameters are four real numbers and are conventionally used to describe the polarisation state of an electromagnetic wave.

S₀ is commonly the total intensity of an electromagnetic wave and in this case by extension represents the total intensity of the bivariate signal, S₀>0.

S₁ and S₂ provide the intensity of rectilinear polarisation \sqrt{S₁²+S₂²}, as well as the direction of the polarisation of the ellipse

$$θ = \frac{1}{2} .$$

atan2(S₂,S₁).

S₃ provides the circular polarisation intensity |S₃|, with its sign providing the direction of rotation.

The reduced Stokes parameters are also defined:

$$si {S}_{0} \neq 0 , ∀ i ∈ \{ 1 , 2 , 3 \} {s}_{i} {=}^{def} \frac{{s}_{i}}{{s}_{0}}$$

Starting from the spectral density obtained for the time-frequency decomposition using a filter bank, a step 71 of computing the Stokes parameters of at least one equivalent ellipse is obtained such that:

$$∀ t ∈ {T}_{↓} , ∀ f ∈ {F}_{+}^{*} , \begin{matrix}{S}_{0} ( t , f ) = 2 \cdot ( {S}_{x} ( t , f ) + {S}_{y} ( t , f ) ) \\ {S}_{1} ( t , f ) = 2 \cdot ( {S}_{x} ( t , f ) - {S}_{y} ( t , f ) )\end{matrix}$$

Starting from the spectral density obtained for the time-frequency decomposition using a short-term single-sided Fourier transform, a step 72 of computing the Stokes parameters of at least one equivalent ellipse is obtained such that:

$$∀ t ∈ {T}_{↓} , ∀ f ∈ {F}_{+}^{*} , \begin{matrix}{S}_{0} ( t , f ) = 2 \cdot ( {\hat{S}}_{x} ( t , f ) + {\hat{S}}_{y} ( t , f ) ) \\ {S}_{1} ( t , f ) = 2 \cdot ( {\hat{S}}_{x} ( t , f ) + {\hat{S}}_{y} ( t , f ) ) \\ {S}_{2} ( t , f ) = 4 \cdot Re ( {\hat{S}}_{xy} ( t , f ) ) \\ {S}_{3} ( t , f ) = 4 \cdot Im ( {\hat{S}}_{xy} ( t , f ) )\end{matrix}$$

Starting from the spectral density obtained for the time-frequency decomposition using a short-term two-sided Fourier transform, a step 73 of computing the Stokes parameters of at least one equivalent ellipse is obtained such that:

$$∀ t ∈ {T}_{↓} , ∀ f ∈ {F}_{+}^{*} , \begin{matrix}{S}_{0} ( t , f ) = 2 \cdot ( \tilde{S} ( t , f ) + \tilde{S} ( t , - f ) ) \\ {S}_{1} ( t , f ) = 4 \cdot Re ( ( t , f ) ) \\ {S}_{2} ( t , f ) = 4 \cdot Im ( ( t , f ) ) \\ {S}_{3} ( t , f ) = 2 \cdot ( \tilde{S} ( t , f ) - \tilde{S} ( t , - f )\end{matrix}$$

Starting from the spectral density obtained for the time-frequency decomposition using a short-term quaternionic Fourier transform, a step 74 of computing the Stokes parameters of at least one equivalent ellipse is obtained such that:

$$t ∈ {T}_{↓} , ∀ f ∈ {F}_{+} , \begin{matrix}{S}_{0} ( t , f ) = Re ( {S}^{o} ( t , f ) ) \\ {S}_{1} ( t , f ) = {Im}_{1 j} ( {S}^{o} ( t , f ) ) \\ {S}_{2} ( t , f ) = {Im}_{1 k} ( {S}^{o} ( t , f ) ) \\ {S}_{3} ( t , f ) = {Im}_{1 i} ( {S}^{o} ( t , f ) )\end{matrix}$$

As an alternative embodiment, the Stokes parameters S₁, S₂, and S₃ are directly computed using the time-frequency decomposition using a quaternionic Fourier transform:

$$∀ t ∈ {T}_{↓} , ∀ f ∈ {F}_{+} , \begin{matrix}{σ}^{o} ( t , f ) = {s}^{o} ( t , f ) \cdot 1 j \cdot \overline{{s}^{o} ( t , f )} \\ {S}_{1} ( t , f ) = {Im}_{1 j} ( {σ}^{o} ( t , f ) ) \\ {S}_{2} ( t , f ) = {Im}_{1 k} ( {σ}^{o} ( t , f ) ) \\ {S}_{3} ( t , f ) = {Im}_{1 i} ( {σ}^{o} ( t , f ) )\end{matrix}$$

Based on these Stokes parameters, a step 75 is carried out of computing the polarisation rate Ø, as well as the aforementioned reduced Stokes parameters, as well as the polarised part of the intensity Sₚ.

$$\begin{matrix}∀ t ∈ {T}_{↓} , ∀ f ∈ {F}_{+} , & ∀ i ∈ \{ 1 , 2 , 3 \} {s}_{i} ( t , f ) = ratio * ( {S}_{i} ( t , f ) , {S}_{0} ( t , f ) ) \\ & ∅ ( t , f ) = \sqrt{{s}_{1}^{2} ( t , f ) + {s}_{2}^{2} ( t , f ) + {s}_{3}^{2} ( t , f )} \\ & {S}_{p} ( t , f ) = ∅ ( t , f ) \cdot {S}_{0} ( t , f )\end{matrix}$$

The polarisation expressed by the polarisation rate Ø highlights the cyclo-stationarity of an equivalent ellipse, namely, the regularity of the trajectory of said ellipse relative to a period of revolution. The polarisation reflects the structuring of said trajectory relative to defined frequencies. The polarisation rate thus can be computed for each time-frequency cell resulting from the time-frequency decomposition in order to highlight the cyclo-stationarity of the rotating shaft for a given frequency.

In addition, a computation step 57 can be implemented in order to determine the Euler parameters a, θ, and χ based on the polarisation spectral density Sₚ and the reduced Stokes parameters:

$$\begin{matrix}∀ t ∈ {T}_{↓} , ∀ f ∈ {F}_{+}^{*} , & a ( t , f ) = \sqrt{{S}_{p} ( t , f )} \\ & θ ( t , f ) = \frac{1}{2} \cdot arctan 2 ( {s}_{2} ( t , f ) , {s}_{1} ( t , f ) ) \\ & χ ( t , f ) = \frac{1}{2} \cdot arcsin ( ratio * ( {s}_{3} ( t , f ) , {S}_{p} ( t , f ) ) )\end{matrix}$$

A fourth Euler parameter φ providing the phase that is the source of the trajectory also can be deduced from the following computation step 58:

$$∀ t ∈ {T}_{↓} , ∀ f ∈ {F}_{+}^{*} , ϕ ( t , f ) = Arg ( {Proj}_{{C}_{1 j}} ( {e}^{1 k \cdot χ ( t , f )} \cdot {e}^{- 1 i \cdot θ ( t , f )} \cdot {s}^{o} ( t , f ) ) )$$

Following the step 50 of determining an equivalent ellipse, notably by computing the Euler parameters of said equivalent ellipse, a step 80 of extracting at least one characterisation indicator of the rotating shaft from parameters of the equivalent ellipse, for example, Euler or Stokes parameters or parameters derived therefrom, is carried out.

In addition, the preceding steps are optionally carried out at least a second time for an additional plane intersecting the axis of rotation of the shaft and distinct from the plane for which these steps were initially carried out. In this embodiment, it is thus possible to carry out a step of comparing the characterisation indicators of the planes.

For example, the at least one characterisation indicator includes the previously described polarisation rate Ø, and/or a circularity indicator (linked to |χ|), and/or an intensity indicator and/or an amplitude indicator, and/or a direction of rotation indicator (linked to the sign of χ), and/or a direction indicator (linked to θ), and/or synchronisation indicator (linked to φ) of the equivalent ellipse.

Each elementary indicator helps to provide a practical and useful characteristic of the rotating system, for example, a high rate of polarisation and a high degree of circularity are probably due to the rotating shaft. Distinguishing this part of the signal, with the complementary part being treated as disturbances, can be useful, for example, for identifying said shaft (for modelling purposes) or for better controlling it in the case of a shaft equipped with magnetic bearings.

Optionally, the at least one characterisation indicator is normalised, in other words, its value ranges between −1 and 1.

The characterisation indicator is provided for one plane, it is then denoted A, or by a comparison between two planes, it is then denoted I.

The characterisation indicator is referred to as a criterion, denoted C, when it is constructed from any characteristic quantity re-evaluated at each instant t. The characterisation indicator is referred to as stationarity, denoted S, when it is based on the stationarity of a quantity over time (maximum when the variation of said variable over time is zero).

Thus, the polarisation rate indicator is denoted:

$$∀ t ∈ {T}_{↓} , ∀ f ∈ {F}_{+} , {AC}_{polarisation} ( t , f ) = Φ ( t , f )$$

For one plane, the intensity indicator is:

$$∀ t ∈ {T}_{↓} , ∀ f ∈ {F}_{+} , {AC}_{intensité} ( t , f ) = {normalise}_{τ ∈ {T}_{↓} v ∈ {F}_{+}} ( {S}_{0} ( t , f ) )$$

With the normalisation function:

$$∀ t ∈ TT , ∀ f ∈ FF , {normalise}_{τ ∈ TT , v ∈ FF} ( x ( t , f ) ) = \frac{x ( t , f )}{{max}_{τ ∈ TT , v ∈ FF}^{*} ( \vert x ( τ , v ) \vert )}$$

TT and FF denote sets of generic dates and frequencies, taking their values from the set of real values R.

For one plane, the amplitude indicator is:

$$∀ t ∈ {T}_{↓} , ∀ f ∈ {F}_{+} , {AC}_{amplitude} ( t , f ) = {normalise}_{τ ∈ {T}_{↓} v ∈ {F}_{+}} ( a ( t , f ) )$$

For one plane, the sign indicator is −1 or 1 depending on the sign of x:

$$∀ t ∈ {T}_{↓} , ∀ f ∈ {F}_{+} , {AC}_{signe} ( t , f ) = signe ( χ ( t , f ) )$$

For one plane, the circularity indicator is:

$$∀ t ∈ {T}_{↓} , ∀ f ∈ {F}_{+} , {AC}_{circularité} ( t , f ) = \frac{\vert χ ( t , f ) \vert}{π / 4}$$

For one plane, the sign stationarity indicator, in other words, the direction of rotation, in other words, the orientation, is:

$$∀ t ∈ {T}_{↓} , ∀ f ∈ {F}_{+} , {AS}_{signe} ( t , f ) = autostat ( {AC}_{signe} ( t , f ) , tol = 0 )$$

With the stationarity function:

$$∀ t ∈ TT , \begin{matrix}pour tol > 0 : & autostat ( x ( t ) , tol ) = {e}^{- \frac{\vert dx ( f ) \vert}{tol}} \\ pour tol = 0 : & autostat ( x ( t ) , 0 ) = ( dx ( t ) == 0 )\end{matrix}$$

For one plane, the circularity stationarity indicator is:

$$∀ t ∈ {T}_{↓} , ∀ f ∈ {F}_{+} , {AS}_{circularité} ( t , f ) = autostat ( {AC}_{circularité} ( t , f ) , tol = 0.1 )$$

For one plane, the direction stationarity indicator, in other words, the geometric inclination of the ellipse, is:

$$∀ t ∈ {T}_{↓} , ∀ f ∈ {F}_{+} , {AS}_{direction} ( t , f ) = autostat ( θ ( t , f ) , tol = 10 \cdot π / 180 )$$

For one plane, the synchronisation stationarity indicator is:

$$∀ t ∈ {T}_{↓} , ∀ f ∈ {F}_{+} , {AS}_{synchro} ( t , f ) = autostat ( φ ( t , f ) , tol = 10 \cdot π / 180 )$$

For two planes, each parameter or indicator is redefined for an additional plane, by denoting these new parameters with an apostrophe, for example, a′.

The amplitude comparative characterisation indicator is:

$$∀ t ∈ {T}_{↓} , ∀ f ∈ {F}_{+} , {IC}_{amplitude} ( t , f ) = {normalise}_{τ ∈ {T}_{↓} v ∈ {F}_{+}} ( \sqrt{a ( t , f ) \cdot {a}^{′} ( t , f )} )$$

The sign comparative characterisation indicator is a Boolean between 0 and 1 depending on the result of the following test:

$$∀ t ∈ {T}_{↓} , ∀ f ∈ {F}_{+} , {IC}_{s i g n e} ( t , f ) = ( A {C}_{s i g n e} ( t , f ) == A {C}_{s i g n e}^{′} ( t , f ) )$$

The circularity comparative characterisation indicator is:

$$∀ t ∈ {T}_{↓} , ∀ f ∈ {F}_{+} , \\ {IC}_{circularit é} ( t , f ) = 1 - reldif ( A {C}_{circularit é} ( t , f ) , A {C}_{circularit é}^{′} ( t , f ) )$$

With the relative error function such that:

$$reldif ( x , y ) = {ratio}^{*} ( 2. \vert x - y \vert , \vert x \vert + \vert y \vert )$$

And with the division function with exception such that:

$${ratio}^{*} ( x , y ) = \begin{matrix}x / y si y \neq 0 \\ 0 sinon\end{matrix}$$

The direction comparative characterisation indicator, in other words, the geometric inclination of the ellipse, is:

$$∀ t ∈ {T}_{↓} , ∀ f ∈ {F}_{+} , {IC}_{direction} ( t , f ) = 1 - reldif ( θ ( t , f ) , {θ}^{′} ( t , f ) )$$

The synchronisation comparative characterisation indicator is:

$$∀ t ∈ {T}_{↓} , ∀ f ∈ {F}_{+} , {IC}_{s y n c h r o} ( t , f ) = 1 - r e l d i f ( ϕ ( t , f ) , {φ}^{′} ( t , f ) )$$

The stationarity and comparative circularity characterisation indicator is:

$$∀ t ∈ {T}_{↓} , ∀ f ∈ {F}_{+} , \\ {IS}_{circularit é} ( t , f ) = a u t o s t a t ( A {C}_{circularit é} ( t , f ) - A {C}_{circularit é}^{′} ( t , f ) , tol = 0.1 )$$

The stationarity and comparative direction characterisation indicator is:

$$∀ t ∈ {T}_{↓} , ∀ f ∈ {F}_{+} , \\ {IS}_{d i rection} ( t , f ) = a u t o s t a t ( θ ( t , f ) - {θ}^{′} ( t , f ) , tol = 10. π / 180 )$$

The stationarity and comparative synchronisation characterisation indicator is:

$$∀ t ∈ {T}_{↓} , ∀ f ∈ {F}_{+} , \\ {IS}_{synchro} ( t , f ) = a u t o s tat ( φ ( t , f ) - {φ}^{′} ( t , f ) , tol = 10. π / 180 )$$

Other indicators can be constructed from the quantities constructed in steps 70 and 50.

Optionally, a step 90 is carried out of introducing the at least one characterisation indicator into a neural network in order to classify said indicator as a function of the rotation of the shaft and to link it to a previously listed anomaly. Anomalies similar to the learning base are then detected.

Optionally, a step 100 is carried out of displaying the at least one extracted characterisation indicator so that it can be read by an operator and so that they can understand potential anomalies in the rotating shaft.

Optionally, a step 101 is carried out of generating a representation of the at least one indicator in the form of images.

The images are, for example, orbits, or time-frequency representations, or representations of phases according to the frequency, or coloured images, with the colour representing the intensity, the direction of rotation or another indicator.

The images also can be composite or hybrid images, for example, in the form of a grid, for example, with several decomposition levels, or can be non-uniform. The image thus has two main axes, namely, abscissa and ordinate axes, corresponding to two variation parameters, for example, time and frequency, while the two axes of the grid cells correspond to two other variation parameters, for example, Cartesian coordinates of a plane orthogonal to the axis of rotation.

Thus, in one embodiment, the grid comprises a set of cells each associated with an image representing one or more indicators, with each cell being arranged according to a time-frequency map.

In another embodiment, the grid comprises a set of cells each associated with an image representing one or more indicators, such as orbits superimposed on force vectors, with each cell being arranged according to a Cartesian coordinate representation. Composite or hybrid images also can be obtained by superimposing several quantities, for example, orbits and/or force fields, in the same system of axes, for example, the Cartesian coordinates of a plane orthogonal to the axis of rotation, with the various quantities optionally being distinguished or supported by shapes or graphic symbols, for example, arrows for representing a vector or a direction.

A step 102 is then carried out of creating a collection of images from the images generated in the generation step 101, with the images being able to be ordered in a selected and/or predetermined order.

A step 103 is then carried out of providing a classification tool with said collection of images, as well as a step 104 of classifying, using the classification tool, the images as a function of the rotation of the rotating shaft and/or the anomalies present in the collection of images.

In a particularly advantageous embodiment, the classification tool is a neural network, preferably a convolutional neural network, which is particularly effective for classifying images. Even more preferably, the convolutional neural network has dimensions that are greater than or equal to the dimensions of the images of the collection of images.

For example, if the collection of images contains only one two-dimensional image, then this is equivalent to classifying only one two-dimensional image and a two-dimensional convolutional neural network can be used.

In another example, if the collection of images is used to represent a three-dimensional image, a three-dimensional convolutional neural network can be used.

In a particular embodiment, each image from the collection is made up of one or more pixels grouped together as a function of the selected resolution, representing the position of the rotor in a fixed orthogonal plane relative to the longitudinal axis of the rotor at a given instant, and the collection of images contains all the images ordered along the axis of increasing time. In this case, if, for example, the rotor orbit described in the fixed orthogonal plane is circular, the collection of images will describe a three-dimensional image representing a helical shape and a three-dimensional convolutional neural network can be used. If the collection of images contains all the images described above but for all the planes orthogonal to the longitudinal axis of the rotor ordered along this axis and for all the instants ordered according to the increasing time, then the collection of images would describe a four-dimensional image, which could be classified by a four-dimensional convolutional neural network.

The collections of images supplying the neural network allow a learning and training base to be formed for the neural network, the classification function of which improves as it receives collections of images.

The classification step 104 optionally allows alarms to be activated for controlling or protecting the rotating shaft and/or its environment, notably when significant anomalies are detected during said classification step 104.

A step 110 of displaying an image of the trajectory of at least one equivalent ellipse also can be carried out.

In a particular embodiment, all the steps of the method are computer-implemented, with the possibility of real time execution, notably in a magnetic bearing control cabinet.

Some terms and functions used in the computations described above are redefined below:

The set of strictly positive frequencies is: F₊*={fⱼ, j=[1, n]}

The set of strictly negative frequencies is: F₋*=−F₊

The following is also defined: F₊={0}∪F;

The following is also defined: F₋=F₋*∪ {0}

The complete set of frequencies is: F=F₋∪F₊=F₋*∪{0} u F;

The generic stationarity function is:

$$∀ t ∈ TT , \begin{matrix}pour tol > 0 : & autostat ( x ( t ) , tol ) = {e}^{- \frac{\vert dx ( t ) \vert}{tol}} \\ pour tol = 0 : & autostat ( x ( t ) , 0 ) = ( dx ( t ) == 0 )\end{matrix}$$

The maximum function with exception is:

$${max}^{*} ( x ) = \begin{matrix}max ( x ) si max ( x ) \neq 0 \\ 1 sinon\end{matrix}$$

The normalisation function is:

$$∀ t ∈ T T , ∀ f ∈ FF , {normalise}_{τ ∈ TT , ν ∈ FF} ( x ( t , f ) ) = \frac{x ( t , f )}{{max}_{τ ∈ TT , ν ∈ FF}^{*} ( \vert x ( τ , ν ) \vert )}$$

The division function with exception is:

$${ratio}^{*} ( x , y ) = \begin{matrix}x / y si y \neq 0 \\ 0 sinon\end{matrix}$$

The relative error function is:

$$reldif ( x , y ) = {ratio}^{*} ( 2. \vert x - y \vert , \vert x \vert + \vert y \vert )$$

The definition of the arctan 2 function is also provided by way of a reminder, with a formulation equivalent to the argument of the complex number x+1μ. y:

$$A r g ( x + 1 μ . y ) = arc tan 2 ( y , x )$$

What is claimed is:

1. A method for characterising the behaviour of a rotating shaft, the method comprising the following steps:
acquiring at least two input signals over a predetermined period, the input signals comprising measurements representing the movement of the rotating shaft, the measurements being non-collinear to each other;
determining two components of the input signals, the components being orthogonal to each other;
merging the two components into a bivariate signal;
time-frequency decomposing the bivariate signal into spectral elements;
determining an equivalent ellipse for each spectral element; and
extracting at least one characterisation indicator of the rotating shaft based on parameters of the equivalent ellipse.

2. The method according to claim 1, wherein the input signals include measurements of the position, or speed, or acceleration, or force, or magnetic field, or magnetic induction of the rotating shaft.

3. The method according to claim 1, wherein the time-frequency decomposition step is carried out using a Fourier, or wavelet, transform, or by filtering, or using a quaternionic Fourier transform.

4. The method according to claim 1, wherein the step of determining an equivalent ellipse includes computing Euler parameters of said equivalent ellipse.

5. The method according to claim 1, comprising a step of computing the spectral density of the time-frequency decomposition, and a step of computing Stokes parameters based on said spectral density.

6. The method according to claim 1, wherein the at least one characterisation indicator includes a polarisation rate, and/or an indicator of circularity and/or amplitude and/or direction of rotation and/or direction and/or synchronisation of an equivalent ellipse.

7. The method according to claim 1, further comprising a step of introducing the at least one characterisation indicator into a neural network in order to classify said indicator as a function of the rotation of the shaft and to link it to a previously listed anomaly.

8. The method according to claim 1, further comprising a step of displaying the at least one extracted characterisation indicator so that it can be read by an operator.

9. The method according to claim 1, comprising a step of generating a representation of the at least one indicator in the form of images, then a step of creating a collection of images based on the images generated in the generation step, a step of providing a classification tool with said collection of images, and a step of classifying, using the classification tool, the images as a function of the rotation of the rotating shaft and/or of the anomalies present in the collection of images.

10. The method according to claim 9, wherein the classification tool is a neural network, preferably a convolutional neural network, even more preferably a convolutional neural network with dimensions that are greater than or equal to the dimensions of the images of the collection of images.

11. The method according to claim 1, comprising a step of displaying an image of at least one equivalent ellipse.

12. The method according to claim 1, wherein the steps of claim 1 are carried out at least a second time for an additional plane intersecting the axis of rotation of the shaft and distinct from said plane, the method further comprising a step of comparing the characterisation indicators of the planes and/or creating new characterisation indicators common to the two planes.

13. The method according to claim 2, wherein the time-frequency decomposition step is carried out using a Fourier, or wavelet, transform, or by filtering, or using a quaternionic Fourier transform.

14. The method according to claim 13, wherein the step of determining an equivalent ellipse includes computing Euler parameters of said equivalent ellipse.

15. The method according to claim 14, comprising a step of computing the spectral density of the time-frequency decomposition, and a step of computing Stokes parameters based on said spectral density.

16. The method according to claim 15, wherein the at least one characterisation indicator includes a polarisation rate, and/or an indicator of circularity and/or amplitude and/or direction of rotation and/or direction and/or synchronisation of an equivalent ellipse.

17. The method according to claim 16, further comprising a step of introducing the at least one characterisation indicator into a neural network in order to classify said indicator as a function of the rotation of the shaft and to link it to a previously listed anomaly.

18. The method according to claim 17, further comprising a step of displaying the at least one extracted characterisation indicator so that it can be read by an operator.

19. The method according to claim 18, comprising a step of generating a representation of the at least one indicator in the form of images, then a step of creating a collection of images based on the images generated in the generation step, a step of providing a classification tool with said collection of images, and a step of classifying, using the classification tool, the images as a function of the rotation of the rotating shaft and/or of the anomalies present in the collection of images.

20. The method according to claim 19, wherein the classification tool is a neural network, preferably a convolutional neural network, even more preferably a convolutional neural network with dimensions that are greater than or equal to the dimensions of the images of the collection of images.
